(19) United States
(12) Patent Application Publication
(10) Pub. No.: US 2017/0297013 A1
(43) Pub. Date: Oct. 19, 2017

(54) Universal Transfer Pipette

(71) Applicant: Jesse Cohen, La Jolla, CA (US)

(72) Inventor: Jesse Cohen, La Jolla, CA (US)

(21) Appl. No.: 15/196,009

(22) Filed: Jun. 28, 2016

Related U.S. Application Data
(60) Provisional application No. 62/322,769, filed on Apr. 14, 2016.

(51) Int. Cl. B01L 3/02; G01N 1/14

(52) U.S. Cl. CPC B01L 3/021; G01N 1/14; B01L 2300/0838; B01L 2300/123; B01L 2400/0481; B01L 2400/0406

(57) ABSTRACT

A universal pipette that can serve as a standard pipette or as a capillary action pipette. A side tube emanates from a main tube in the pipette. The side tube comprises a through hole which is sealed with a through hole tab. The through hole tab can be broken off by a user, thereby removing the seal and exposing the through hole to outside of the pipette. Liquid can now easily be drawn into the tip of the pipette by virtue of capillary action which is now enabled do to the exposed through hole.

### CROSS REFERENCE TO RELATED APPLICATIONS

This application claims benefit to U.S. provisional application 62/322,769, which his incorporated by reference herein in its entirety.

### BACKGROUND OF THE INVENTION

### Field of the Invention

The present general inventive concept is directed to a method and apparatus directed to a universal transfer pipette.

### Description of the Related Art

A standard transfer pipette operates by squeezing a bulb at the end of the pipette, then positioning a tip of the pipette in a liquid, and then releasing the bulb thereby sucking in the liquid into the pipette. The liquid inside the pipette can then be transferred by positioning the tip to a desired location and squeezing the bulb again, releasing the liquid.

A capillary action pipette operates a little differently than a standard transfer pipette. The capillary action pipette has a small hole towards the middle. When the capillary action pipette is placed alongside a liquid, the liquid (by virtue of the hole) will automatically be sucked into the pipette (no squeezing/releasing of the bulb is necessary). Then, after the pipette tip is positioned into a desired location, a bulb on the capillary action pipette is then squeezed to release the liquid out of the tip.

### SUMMARY OF THE INVENTION

It is an aspect of the present invention to provide an improved pipette.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing of a pipette with a through hole tab intact, according to an embodiment;

FIG. 2 is a drawing of a pipette with the through hole tab removed, according to an embodiment;

FIG. 3 is an isometric drawing of the pipette in FIGS. 1-2, according to an embodiment;

FIG. 4 is a drawing of a cross section of a pipette with an angled side tube, according to an embodiment;

FIG. 5 is a drawing of a cross section of a pipette with an angled side tube and a removed through hole tab, according to an embodiment;

FIG. 6 is an isometric drawing of the pipette in FIGS. 4-5, according to an embodiment;

FIG. 7 is a cross section of a pipette with both an intact side through hole tab and an intact tip tab, according to an embodiment;

FIG. 8 is a cross section of a pipette with a removed side through hole tab and a removed tip tab, according to an embodiment;

FIG. 9 is cross section of a pipette with the removed side through hole tab turned around and the removed tip tab turned around, according to an embodiment;

FIG. 10 is a cross section of a pipette with the through hole tab reinserted and the tip tab reinserted, according to an embodiment;

FIG. 11 is a cross section of a pipette with an intact tip tab, according to an embodiment;

FIG. 12 is a cross section of a pipette with the tip tab removed, according to an embodiment;

FIG. 13 is a cross section of a pipette with the tip tab turned around and reinserted, according to an embodiment;

FIG. 14 is an isometric drawing of the pipette from FIGS. 11-13, according to an embodiment;

FIG. 15 is a cross section of a pipette with a tip tab intact and a through hole tab removed, according to an embodiment;

FIG. 16 is a cross section of a pipette with a tip tab intact and a clamp sealing the through hole, according to an embodiment;

FIG. 17 is an isometric drawing of a pipette with a heat crimp seal through hole tab, according to an embodiment;

FIG. 18 is a cross section of a pipette with liquid being ejected, according to an embodiment;

FIG. 19 is a cross section of a pipette with liquid drawn to a stop by the through hole tube, according to an embodiment;

FIG. 20 is a cross section of a pipette being squeezed, according to an embodiment;

FIG. 21 is a cross section of a pipette with liquid drawn to a high stop point, according to an embodiment;

FIG. 22 is a front view drawing of a pipette with no through hole tab or tip tab, according to an embodiment; and

FIG. 23 is a side view drawing of a pipette with no through hole tab or tip tab, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a transfer pipette which can be used as either a standard transfer pipette or a capillary action pipette or a storage pipette. A through hole tab is a tear away tab which is present on a side tube towards the lower end of the pipette which seals a through hole in the side tube. The through hole tab is a complete seal of the through hole and when the through hole tab is present, then the pipette acts as a standard transfer pipette because the through hole cannot communicate with the outside of the pipette and hence the through hole is not a “functional” hole.

The through hole tab is integrated into the pipette and completely seals the through hole from the outside of the pipette (thus while the through hole tab (or “tab”) is intact the hole has no function as it is not really a “hole” to the outside of the pipette because the tab completely seals the hole). The through hole tab (tab) can be easily torn by hand (e.g., twisted until it breaks off) and it will break off easily. This exposes the through hole and allows the inside of the pipette to communicate with the outside of the pipette through the through hole inside the side tube. Now the pipette can be used as a capillary action pipette by contacting the tip of the pipette with liquid and the liquid should naturally be drawn up into the pipette by virtue of the open through hole. Squeezing the bulb would then eject the liquid out of the pipette exiting through the tip.

Note that once a tab has been twisted off, it cannot be replaced back onto the pipette (however, in embodiments discussed below this is not true as the tabs can be replaced and re-seal the through hole or tip that they originally sealed. Each pipette is typically disposable.

Therefore, one universal pipette can function both as a standard transfer pipette (by leaving the through hole tab intact) or as a capillary action pipette (by breaking/twisting the through hole tab off thereby causing a hole from the outside of the pipette passing through the inside of the pipette). Before the through hole tab is broken off, the only entrance/exit into/out of the pipette is through the tip, but after the through hole tab is broken off an additional entrance/exit to the inside of the main tube (which is hollow to store liquid) is now created through the through hole. Thus, instead of having to stock both standard transfer pipettes and capillary action pipettes, now only one type of pipette can be stocked which can serve both purposes. Thus, a path exists through the through hole in the side tube to the inside of the hollow main tube.

A side tube is what houses the through hole and can direct the through hole in a particular direction. In one embodiment, the side tube can be at a right angle (perpendicular) to the surface of the pipette (the main tube). In another embodiment, the side tube can be at any angle to the main tube (e.g., such as the following: 20 degrees, 45 degrees, greater than 20 degrees, from 20 to 60 degrees, from 40 to 50 degrees, 55 degrees, 90 degrees, up to 160 degrees, 0 to 180 degrees, 20 to 60 degrees, 40 to 50 degrees, 55 degrees, 90 degrees, 10 to 170 degrees, 20 to 160 degrees, etc.)

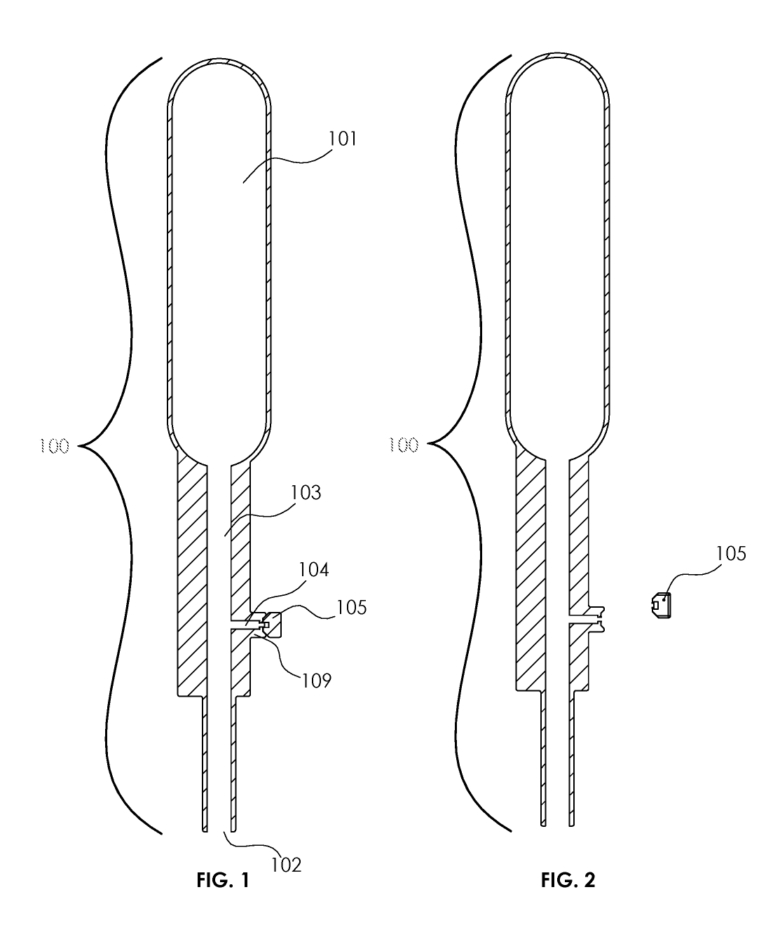

FIG. 1 is a drawing of a pipette with a through hole tab intact, according to an embodiment.

A pipette 100 has a bulb 101 (which can be made of rubber, plastic or other malleable material and can be squeezed thereby exerting air pressure on liquid inside the main tube 103 causing it to eject). The main tube 103 is a hollow area inside the pipette in which liquid can be drawn in from a tip 102. Note that all of the pipette embodiments have these basic parts.

A side tube 109 is approximately in the middle of the main tube and connects internally to the main tube. The side tube has a hollow area inside (a through hole 104) allowing air to flow or liquid to flow and be stored. The main tube 103 connects internally to the through hole 104 inside of the side tube so liquid can flow therebetween. A through hole tab 105 prevents air or liquid from flowing out of the through hole 104 as it makes a complete seal with an end of the through hole 104.

FIG. 2 is a drawing of a pipette with the through hole tab removed, according to an embodiment.

The through hole tab is removed (e.g., pulled off, twisted off, etc.) thereby exposing the through hole 104 to the air. This pipette can now be used as a capillary action pipette.

Note that in FIGS. 1 and 2 the opening between the through hole and the inside of the main tube is clearly shown thereby illustrating the path between inside of the main tube and the through hole. Note that the remaining figures depict the same structure (that there is a path between the inside of the main tube and the through hole) but use a different drawing style so that a line appears between the main tube and the through hole but this line just represents the joinder of the through hole to the main tube (but the path between the through hole and the main tube is still there). The structures in all of the drawings are the same (a joinder between the through hole and the hollow main tube) but are illustrated differently in FIGS. 1, 2 and the remaining drawings. All of the pipettes described herein have a path between the through hole and inside the main tube and there is no barrier or blockage therebetween.

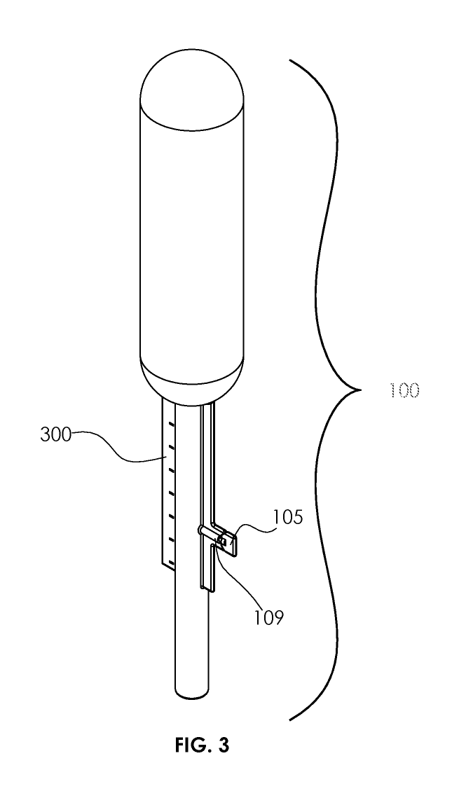

FIG. 3 is an isometric drawing of the pipette in FIGS. 1-3, according to an embodiment.

Graduations 300 can be used to measure the amount of liquid in the pipette.

When the through hole tab is removed (exposing the through hole in the side tube), in an embodiment the side tube can be re-sealed (by putting back in the through hole tab or a different plug/cap that press fits inside the through hole thereby sealing it). This sealing can be used to seal the pipette after it liquid has been sucked up it. To seal the side tube back up (after removal of the through hole tab), the same through hole tab can be used to seal it back up by inserting it back into the through hole. Alternatively, a separate plug, cap, or heat crimp seal can be used (using a heating element to heat the crimp thereby forming a seal) to seal the through hole. A clamped seal can also be used (which uses a clamp tool to form the seal).

Note that in one embodiment, the through hole tab is removed by pulling it out (or twisting it out) of the through hole. An end of the through hole tab has a plug (thus, after the through hole tab is removed it should be saved, and the side tube can then be sealed up again by pushing the plug back into the through hole. The through hole tab has an enlarged grip (opposite to the plug) in which the user can press his fingers around to twist (or pull) off (the grip opposite the plug).

A sample method of how this can work for storage applications is as follows. In step one, the through hole (also referred to as side hole) is exposed by removing the through hole tab (but not discarding the tab as it will be needed later to seal the through hole back up). In step two, liquid is sucked into the pipette. This can be done by depressing the bulb and sucking in the liquid through the through hole. In step three, the through hole is now sealed (either with the same through hole tab that was originally torn off (which is simply pushed back into the through hole) or separate cap/plug). The plug can be a press in with a protrusion to hermetically seal the through hole. A cap (used in place of a plug for the same purpose, to seal the through hole) has a screw in thread which screws into the side tube. Now, the pipette contains liquid and the through hole is sealed.

Note that the tip also can have a tip tab which is left intact in steps one, two and three. The tip tab operates, functions, and is the same structurally as the through hole tab (although can be different in size). The tip tab can reseal the tip in any manner as the through hole tab can seal the though hole. In addition, any mechanism described herein to seal the through hole can also be used to seal the tip (once opened). The pipette is now completely sealed off (with the liquid inside) from the outside with both tabs intact (the through hole tab and the tip tab).

The tip tab operates in the same manner as the through hole tab located on the through hole. The tip tab completely seals the tip (thereby keeping the contents of the pipette isolated from outside of the tip) until it is twisted or broken off. Both the tip tab and the through hole tab are integrally manufactured with the pipette (and hence are a part of it until twisted/broken off) and can be the same structurally (or perhaps difference sizes).

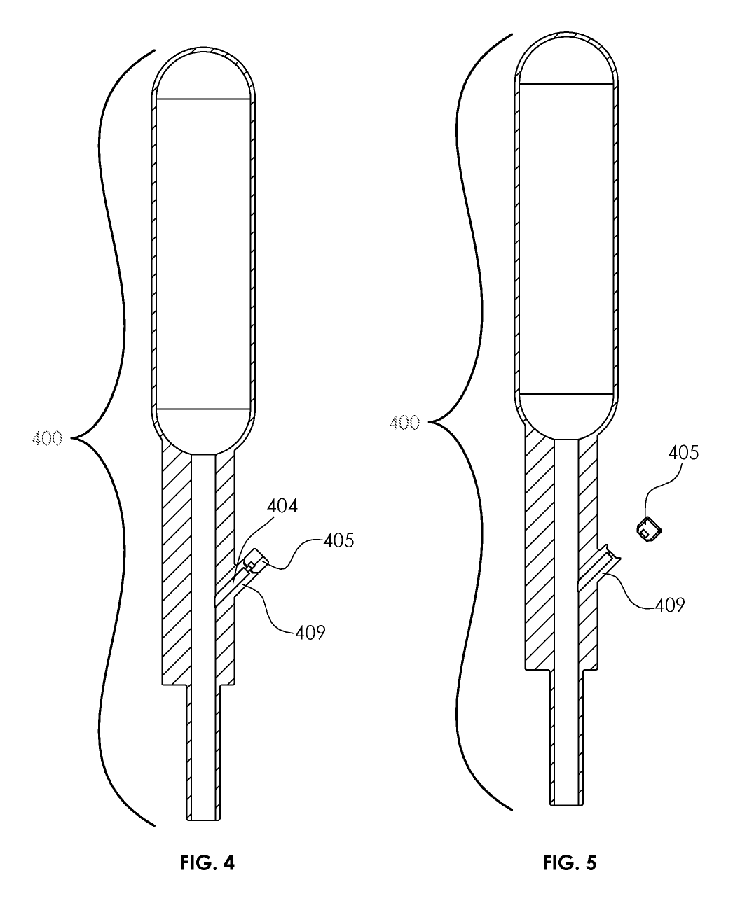

FIG. 4 is a drawing of a cross section of a pipette with an angled side tube, according to an embodiment.

Note a side tube 409 and through hole 404 are at approximately a 45 degree angle to the main tube. A through hole tab 405 completely seals the through hole 404 from the outside of the pipette 400.

FIG. 5 is a drawing of a cross section of a pipette with an angled side tube and a removed through hole tab, according to an embodiment.

The through hole tab 405 has been removed and the through hole 404 is now exposed to the outside. This pipette can now be used as a capillary action pipette. The angle may help the flow of liquid through the main tube.

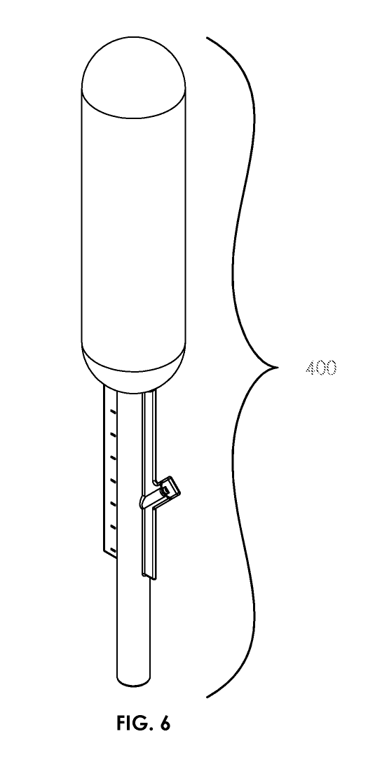

FIG. 6 is an isometric drawing of the pipette in FIGS. 4-5, according to an embodiment.

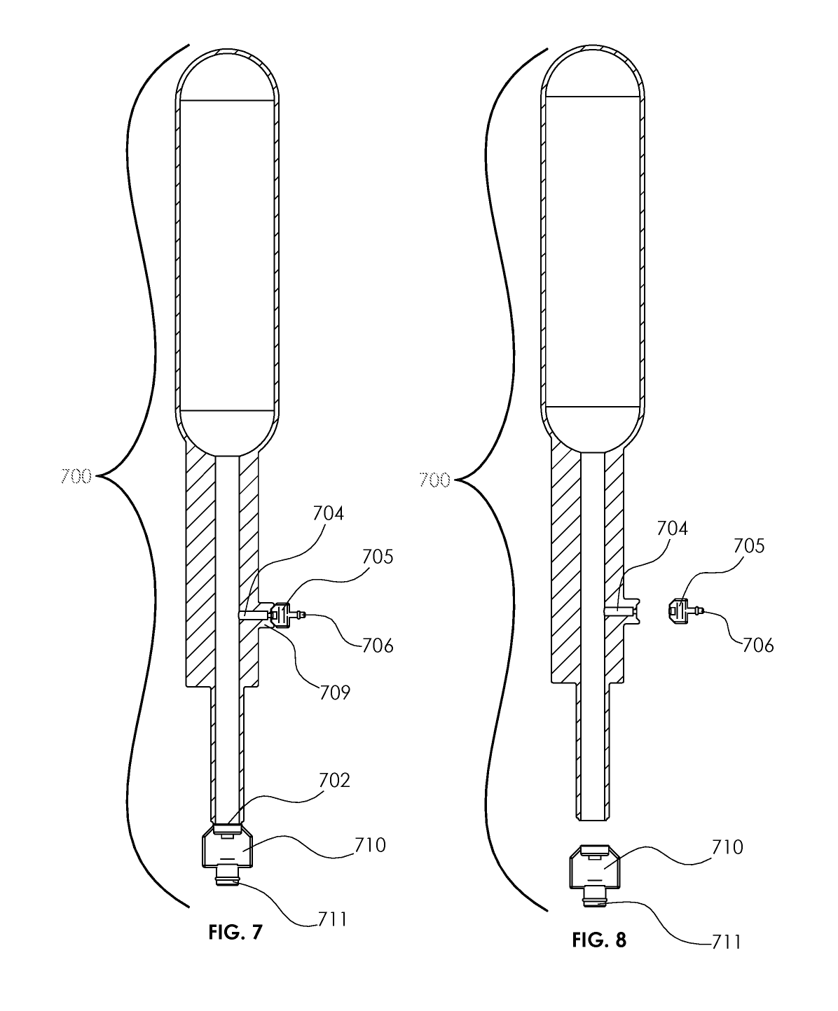

FIG. 7 is a cross section of a pipette with both an intact side through hole tab and an intact tip tab, according to an embodiment.

A through hole 704 is sealed with a through hole tab 705. In this embodiment, the through hole tab is a plug cap which has a grip 705 and a plug 706. This pipette 700 also has a tip tab 710 which completely seals the tip 702 from the outside of the pipette. The tip tab has a tip tab grip 710 connected to a tip tab plug 711

FIG. 8 is a cross section of a pipette with a removed side through hole tab and a removed tip tab, according to an embodiment.

The through hole tab is removed (exposing the through hole) and the tip tab is also removed (exposing the tip).

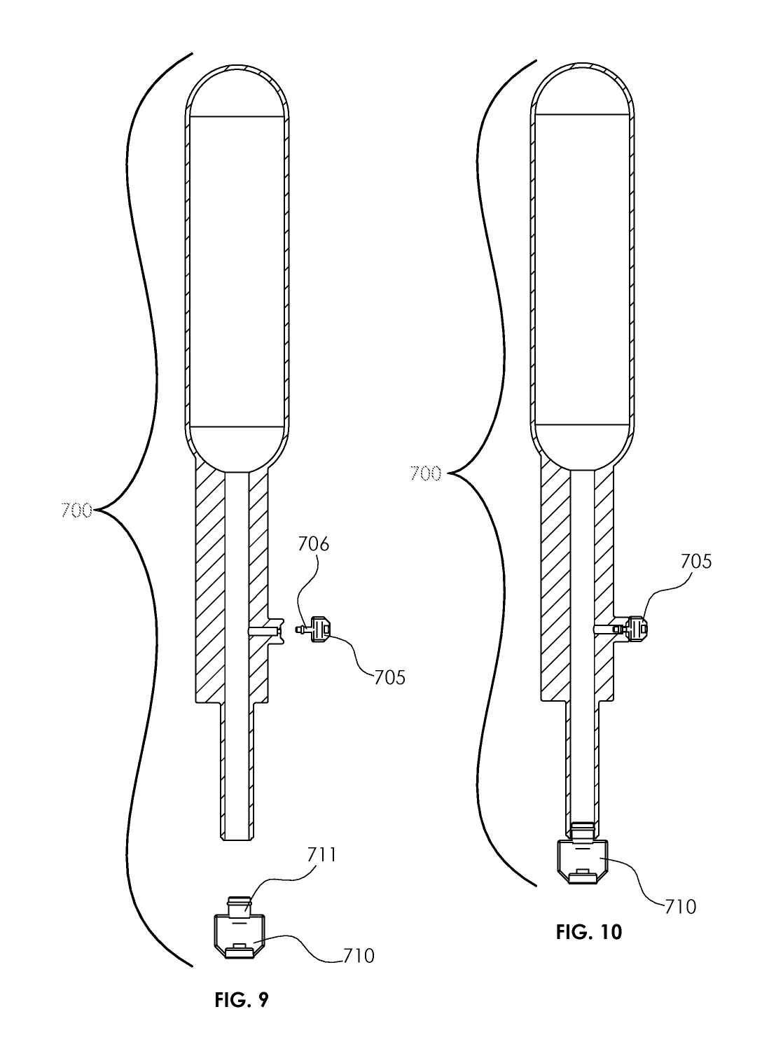

FIG. 9 is cross section of a pipette with the removed side through hole tab turned around and the removed tip tab turned around, according to an embodiment.

The through hole tab is turned around so that the plug is now facing the through hole. The tip tab is turned around so now the tip tab plug is facing the hole

FIG. 10 is a cross section of a pipette with the through hole tab reinserted and the tip tab reinserted, according to an embodiment.

The plug of the through hole tab is inserted into the side tube thereby sealing the through hole. The tip tab plug 711 is inserted into the tip thereby sealing the tip.

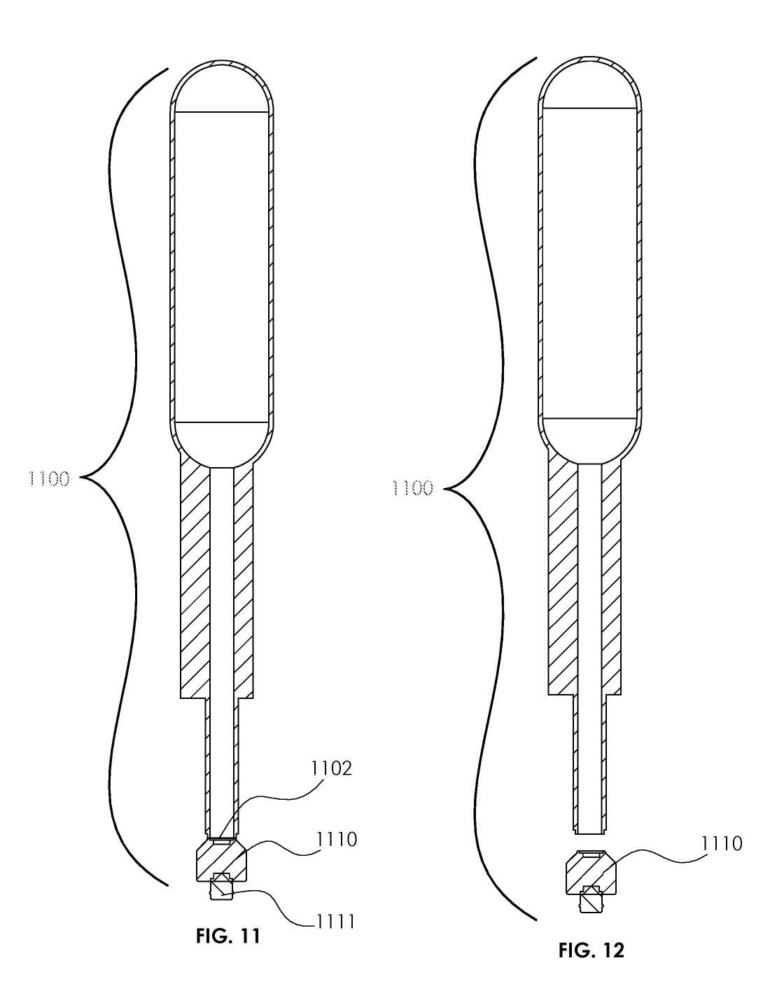

FIG. 11 is a cross section of a pipette with an intact tip tab, according to an embodiment.

The pipette 1100 does not have a side tube but has a tip tab sealing its tip 1102. The tip tab comprises a grip 1110 and a plug 1111.

FIG. 12 is a cross section of a pipette with the tip tab removed, according to an embodiment.

The tip tab is twisted (or pulled, etc.) off the tip of the pipette, thereby exposing the tip to the outside.

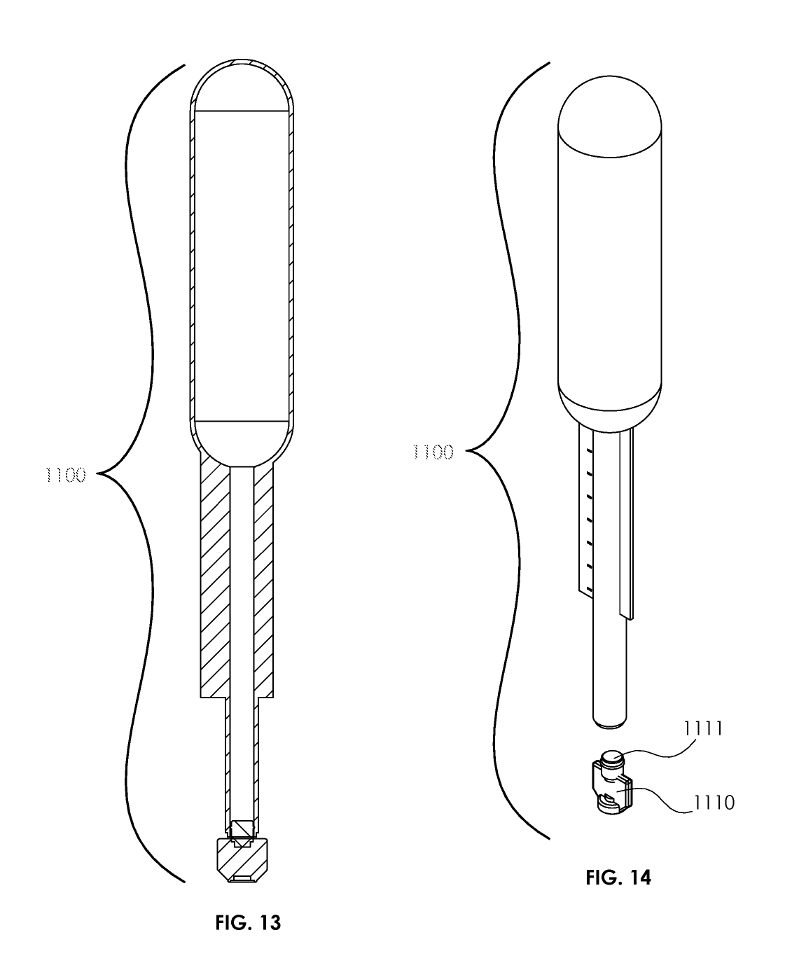

FIG. 13 is a cross section of a pipette with the tip tab turned around and reinserted, according to an embodiment.

The plug of the tip tab is inserted into the tip of the pipette 1100, thereby sealing the contents from the outside.

FIG. 14 is an isometric drawing of the pipette from FIGS. 11-13, according to an embodiment.

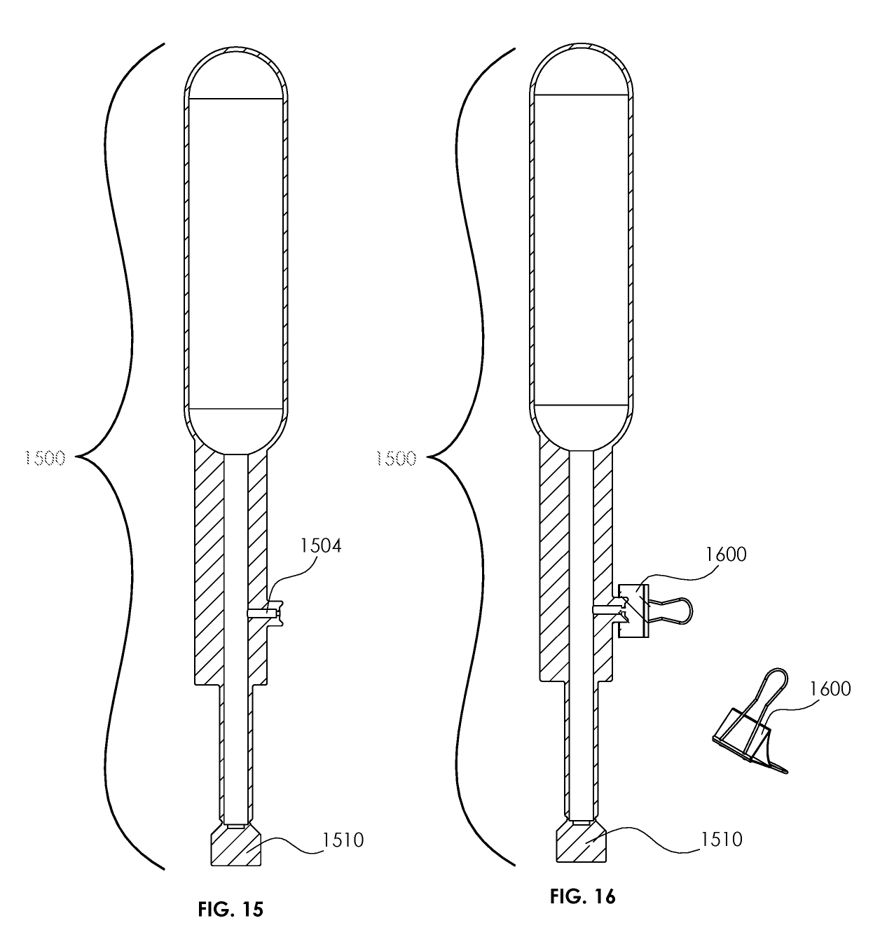

FIG. 15 is a cross section of a pipette with a tip tab intact and a through hole tab removed, according to an embodiment.

The through hole 1504 is exposed to the outside because any through hole tab was removed from the pipette 1500. A tip tab 1510 is present sealing the tip.

FIG. 16 is a cross section of a pipette with a tip tab intact and a clamp sealing the through hole, according to an embodiment.

A clamp 1600 (such as a spring loaded clamp) is activated over the side tube, thereby sealing the through hole. The clamp 1600 can be considered a type of through hole tab but operates using a spring loaded mechanism which presses force on both sides of the side tube (and hence the through hole) thereby sealing it. The clamp 1600 can be used and reused. The clamp (or any through hole sealer) can be installed on the pipette initially (when the user receives it) or placed on the pipette by the user at a later time. In the embodiments which include a twist off (or tear off) through hole tab which is integrally molded onto the pipette, then of course this pipette must come installed with this through hole tab intact. Note that a through hole sealer comprises any type of sealing mechanism used to seal the through hole and comprises through hole tabs (of any kind), clamps, heat crimp seals, anything else mentioned herein which can be used to seal the through hole or known in the art. Note that while in one embodiment the side tube is made of a hard material, in another embodiment the side tube may optionally be made of a malleable material (e.g., rubber, vinyl, thin polyethylene etc.) so that a clamp can be used to close and seal the through hole (while the remaining part of the pipette can be malleable (in one embodiment) or hard (in another embodiment). The main tube can be made of a hard material (e.g., glass, plastic, etc.) which would not be malleable or of a soft material (plastic, etc.) which would be malleable.

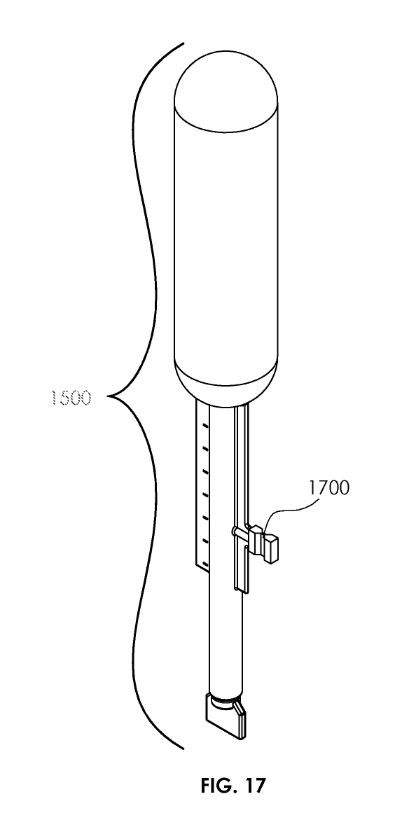

FIG. 17 is an isometric drawing of a pipette with a heat crimp seal through hole tab, according to an embodiment.

A heat crimp seal 1700 (is considered a through hole tab and any other through hole tab can be used as well) is used to seal the through hole and can be applied using a heat source (e.g., heat crimper/heat sealer). The heat crimp seal 1700 can be removed by cutting it off.

The pipette which has both a through hole tab and a tip tab can be used in numerous ways. For example, the pipette can be filled and sealed with liquid. One way this can be accomplished is the through hole tab can be removed and then liquid can be placed into the pipette by squeezing the bulb and then contacting the through hole with liquid and then releasing the bulb thereby sucking the liquid into the main tube. The through hole can now be sealed with the through hole tab.

Now, with liquid sealed inside the pipette, the pipette can be stored. When it is time to release the liquid, the tip tab at the tip is now removed (twisted or pulled off), thereby exposing the inner contents of the pipette. The bulb can then be depressed, thereby releasing the liquid stored in the pipette. In this manner, the pipette can be used to collect liquid, stored it in a hermetically sealed contained, and then discharge the liquid when desired. The same process can be performed through the tip instead of the through hole (i.e. by removing the tip tab, sucking liquid into the pipette, then replacing the tip tab).

Note the two tabs (the through hole tab and the tip tab) can be identical although they may need to be different sizes in order to completely fit and seal into their respective holes. The pipette can come with both tabs (the tip tab and the through hole tab) intact (and sealed) and ready to be twisted off or just either one of these tabs can be present.

In another embodiment, another workflow can be accomplished. With the original pipette having both tear away tabs intact, the tip tab on the tip is twisted off. The bulb is depressed and then liquid is sucked into the pipette by locating the tip near the liquid and releasing the bulb. The tip tab is then put back into the tip therefore sealing the tip (and hence the liquid is now sealed inside the pipette). When ready, the liquid can be discharged from the pipette as discussed herein, by removing the tip tab and depressing the bulb to discharge the liquid.

Yet another workflow can be accomplished. With the original pipette having both tear away tabs intact (the through hole tab and the tip tab), both tear away tabs are pulled (or twisted) off, and then liquid is sucked into the pipette using the capillary action method (the tip is placed near liquid which automatically draws the liquid inside the pipette). Then, the tip tab is sealed back onto the tip, and the through hole tab is also sealed back onto the through hole. The liquid is now completely sealed inside the pipette (free from outside contamination) and when ready, the liquid can be discharged from the pipette by again removing the tip tab and depressing the bulb, thereby discharging the liquid out the tip.

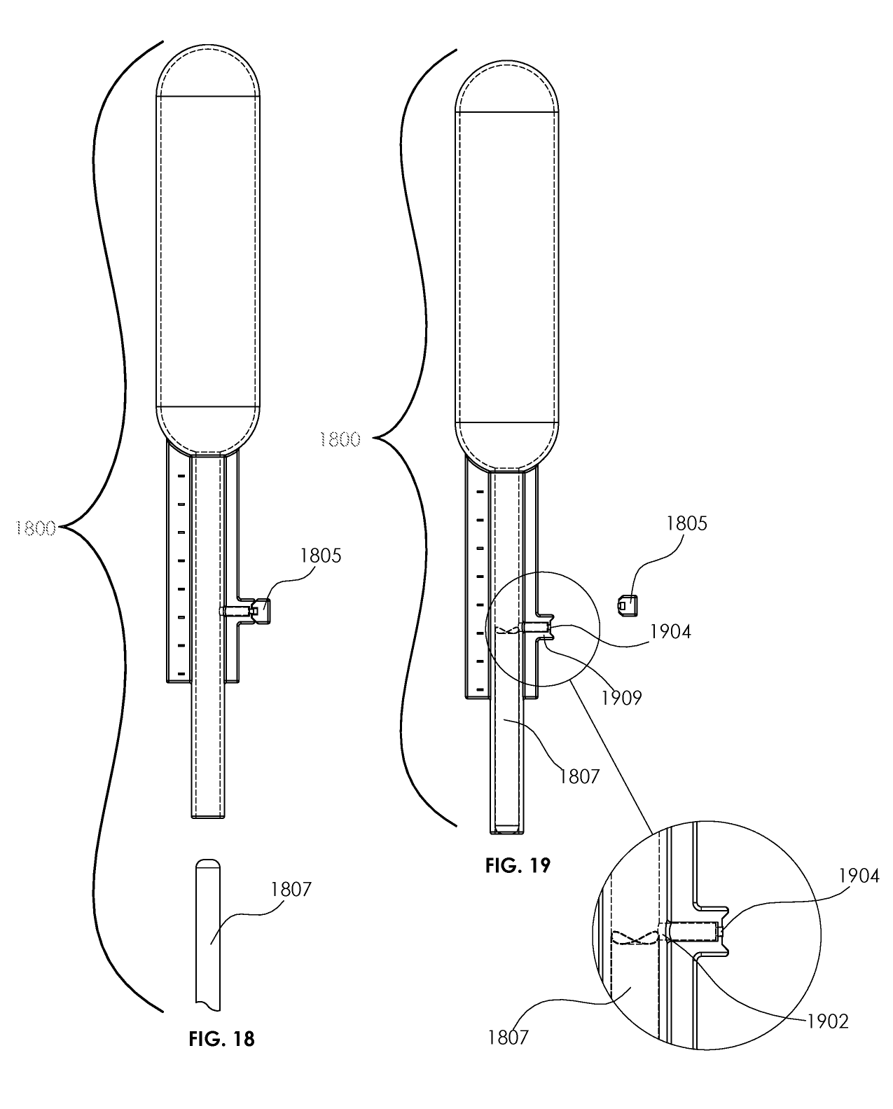

FIG. 18 is a cross section of a pipette with liquid being ejected, according to an embodiment.

Liquid 1807 is squeezed out of the pipette 1800. A through hole tab 1805 seals the through hole from the outside.

FIG. 19 is a cross section of a pipette with a stop point aligned with the through hole 1904, according to an embodiment.

The through hole tab 1805 is twisted off from the through hole 1904. Liquid 1807 has been drawn from the tip inside the main tube up to a stop point 1902. Because the through hole tab 1805 has been removed, liquid can easily be drawn into the main tube of the pipette 1800 via the tip.

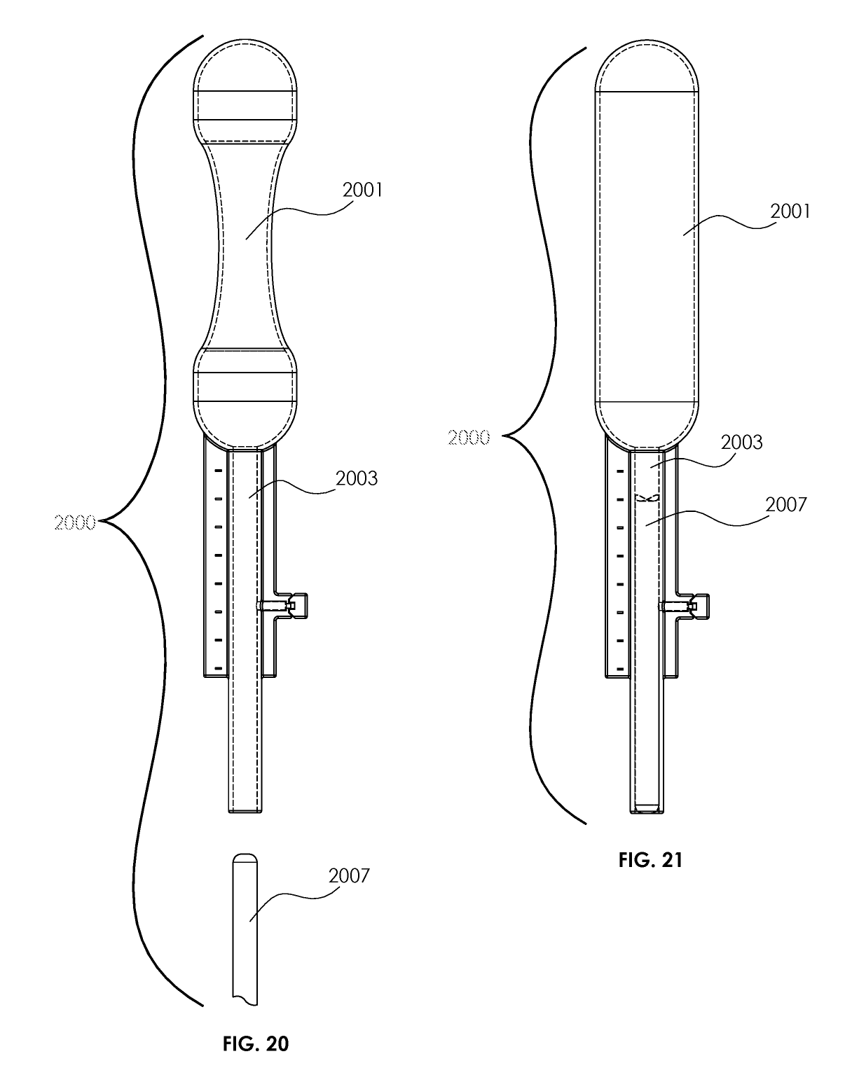

FIG. 20 is a cross section of a pipette bulb being squeezed, according to an embodiment.

The bulb 2001 is squeezed, thereby exerting air pressure towards the main tube thereby discharging any liquid 2007 that was present in the main tube.

FIG. 21 is a cross section of a pipette with liquid drawn to a high stop point, according to an embodiment.

The liquid 2002 in this example has been drawn to a high stop point near the bulb.

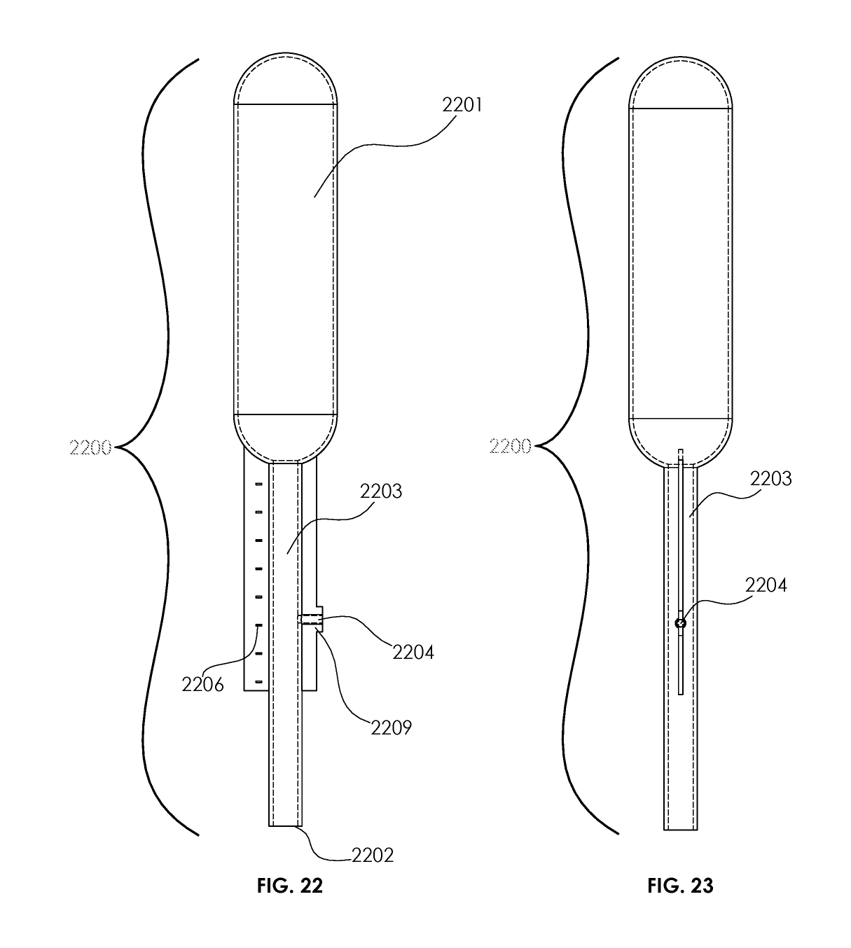

FIG. 22 is a front view drawing of a pipette with no through hole tab, according to an embodiment.

A pipette 2200 has a through hole 2204 but originally comes with no through hole tab and therefore the through hole 2204 is exposed to the outside. It also comes with no tip tab. The main tube 2203 is hollow right down to a tip 2202. A liquid 2203 can be drawn inside the main tube 2203 through the tip 2202 by virtue of the through hole 2204 being exposed. Graduations 2206 can be used to measure the amount of liquid inside the pipette.

Note that this pipette differs from a prior art capillary action tube in that it has the side tube 2209 and is configured to receive a through hole tab to plug the through hole 2204. The through hole tab (not pictured in FIG. 22 but can be any of the other through hole tabs described/illustrated herein) can be inserted into the through hole 2204 (thus sealing it) and removed, over and over again.

FIG. 23 is a side view drawing of a pipette with no through hole tab, according to an embodiment.

Through hole 2204 is inside on the side tube which connects to the main tube 2203.

In one embodiment, the entire pipette can be blowmolded as one integral piece (including the main tube, the through hole tab, the tip tab, the bulb, the side tube, etc.). All parts of the pipette can be made from thermoplastic (e.g., polyethylene) or any other material (glass, PVC, plastic, etc.) If the pipette is made out of polyethylene, it can be slightly malleable (if the thickness of the pipette walls is small) and can be hard (if the thickness of the pipette walls is larger). In one embodiment, the bulb could be made of a malleable material (such as rubber) so it can be depressed (and when released would naturally expand back to its natural shape) and not blowmolded with the rest of the pipette. In an embodiment, parts of the pipette not blowmolded with the pipette (e.g., the bulb if it is not blowmolded with the rest of the pipette) can be made of a different material than the rest of the pipette (while typically all parts made via blowmolding would all be made of the same material). The bulb can be inserted onto the pipette after both are manufactured. Any other manufacturing method can be used to manufacture the pipette as well, such as injection molding, 3-D printing, etc. the pipette and all its parts (with the exception of the bulb) can be manufactured with a transparent material.

The pipette described herein can be manufactured in numerous possible ways, the following are only two examples: a) the entire pipette (all parts) can be blowmolded in its entirety (including the main tube, side tube, through hole tab, tip tab, bulb, etc.) The pipette will be made of a slightly malleable material (e.g., thermoplastic such as polyethylene, other plastic, vinyl, etc.) so that the bulb can be depressed; b) all parts of the pipette but for the bulb can be blowmolded in its entirety (using a hard material (e.g., glass) or malleable material) but the bulb will be manufactured separately (out of a malleable material) and inserted onto the end of the pipette.

Embodiments shown herein show a pipette that comes with a through hole tab and/or a tip tab. Depending on the embodiment, the pipette can come with only one of these removable structures or both or neither.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A pipette, comprising:
a bulb connected to one end of a hollow main tube;
a tip at an end of the main tube opposite to the bulb;
a side tube originating from the main tube comprising a through hole which leads into the hollow main tube; and
a through hole tab integrally attached to the side tube and sealing the through hole and configured to twist off thereby exposing the through hole inside the side tube.

2. The pipette as recited in claim 1, further comprising a tip tab integrally attached to the tip and sealing the tip and configured to twist off thereby exposing the tip.

3. The pipette as recited in claim 1, wherein the through hole tab is configured to fit back inside the through hole after being removed thereby sealing the through hole.

4. The pipette as recited in claim 2, wherein the tip tab is configured to fit back inside the tip after being removed thereby sealing the tip.

5. The pipette as recited in claim 1, wherein the side tube is at an angle to the main tube.

6. The pipette as recited in claim 5, wherein the angle ranges between 20 and 60 degrees.

7. A pipette, comprising:
a hollow main tube;
a tip at an end of the hollow main tube;
a side tube originating from the main tube comprising a through hole which leads into the hollow main tube.

8. The pipette as recited in claim 7, further comprising a through hole sealer sealing the through hole.

9. The pipette as recited in claim 8, wherein the through hole sealer is a through hole tab.

10. The pipette as recited in claim 8, wherein the through hole sealer is a heat crimp seal.

11. The pipette as recited in claim 8, wherein the through hole sealer is a clamp.

12. The pipette as recited in claim 8, wherein the through hole sealer is removable.

13. The pipette as recited in claim 8, wherein the through hole sealer is removable and reinsertable into the through hole.

14. The pipette as recited in claim 8, wherein the side tube is at an angle to the main tube.

15. The pipette as recited in claim 7, wherein the pipette comprising the main tube, the tip, the side tube, and a bulb is manufactured all at once by blowmolding.

16. The pipette as recited in claim 15, wherein the pipette is made from a malleable thermoplastic.

17. The pipette as recited in claim 16, wherein the malleable thermoplastic is polyethylene.

18. A method, comprising:
providing:
a bulb connected to one end of a hollow main tube;
a tip at an end of the main tube opposite to the bulb;
a side tube originating from the main tube comprising a through hole which leads into the hollow main tube;
a through hole tab integrally attached to the side tube and sealing the through hole and configured to twist off thereby exposing the through hole inside the side tube
removing the through hole tab; and
contacting the tip with a liquid, thereby filling the main tube with the liquid.

19. The method as recited in claim 18, further comprising reinserting the through hole tab into the side tube thereby sealing the through hole.

20. The method as recited in claim 19, further comprising inserting a tip tab into the tip thereby sealing the tip.
